(19) United States
(12) Patent Application Publication
(10) Pub. No.: US 2015/0180133 A1
(43) Pub. Date: Jun. 25, 2015

(54) METAMATERIAL WAVEGUIDE LENS

(71) Applicant: Duke University, Durham, NC (US)

(72) Inventors: John Hunt, Durham, NC (US); Nathan Kundtz, Durham, NC (US); David R. Smith, Durham, NC (US)

(21) Appl. No.: 14/552,068

(22) Filed: Nov. 24, 2014

Related U.S. Application Data
(63) Continuation of application No. 13/452,177, filed on Apr. 20, 2012, now abandoned.
Application No. 13/452,177 is a continuation-in-part of application No. 12/545,373, filed on Aug. 21, 2009.
(60) Provisional application No. 61/477,882, filed on Apr. 21, 2011.
(60) Provisional application No. 61/479,071, filed on Apr. 26, 2011.
(60) Provisional application No. 61/091,337, filed on Aug. 22, 2008.

(51) Int. Cl. H01Q 15/04; H01Q 19/06; G05B 19/418; H01Q 3/44

(52) U.S. Cl. CPC H01Q 15/04; H01Q 3/44; H01Q 19/065; G05B 19/41865

(57) ABSTRACT

A metamaterial waveguide structure is disclosed. In some approaches the metamaterial waveguide structure is compressed along an optical axis using transformation optics techniques. An example is a Rotman lens that is compressed by 27 percent along the optical axis while maintaining the beam steering range, gain and side lobe amplitudes over a broad frequency range. In some approaches the metamaterial waveguide structure includes a plurality of complementary metamaterial elements patterned on a conducting surface of the waveguide.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications, including any priority claims, is incorporated herein by reference to the extent such subject matter is not inconsistent herewith.

### RELATED APPLICATIONS

For purposes of the USPTO extra-statutory requirements, the present application constitutes a continuation of U.S. patent application Ser. No. 13/452,177, entitled A METAMATERIAL WAVEGUIDE LENS, naming DAVID R. SMITH, NATHAN KUNDTZ, AND JOHN HUNT as inventors, filed Apr. 20, 2012, which claims priority to and the benefit of U.S. Patent Application No. 61/477,882, entitled METAMATERIAL-MODIFIED ROTMAN LENS AND METHODS OF USE, naming DAVID R. SMITH, NATHAN KUNDTZ, AND JOHN HUNT as inventors, filed Apr. 21, 2011, and U.S. Patent Application No. 61/479,071, entitled A METAMATERIAL WAVEGUIDE LENS, naming DAVID R. SMITH, NATHAN KUNDTZ, AND JOHN HUNT as inventors, filed Apr. 26, 2011.

For purposes of the USPTO extra-statutory requirements, the present application constitutes a continuation-in-part application of U.S. patent application Ser. No. 12/545,373, entitled METAMATERIALS FOR SURFACES AND WAVEGUIDES, naming DAVID R. SMITH, RUOPENG LIU, TIE JUN CUI, QIANG CHENG, AND JONAH N. GOLLUB as inventors, filed Aug. 21, 2009, which claims priority to and the benefit of U.S. Patent Application No. 61/091,337, filed Aug. 22, 2008.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### TECHNICAL FIELD

The application discloses apparatus and methods that relate to metamaterials for waveguide lenses such as Rotman lenses.

### SUMMARY

A metamaterial waveguide structure is disclosed. In some approaches the metamaterial waveguide structure is compressed along an optical axis using transformation optics techniques, providing a compressed structure such as a compressed Rotman lens. The metamaterial waveguide structure may include a plurality of complementary metamaterial elements patterned on a conducting surface of the waveguide.

The technology herein relates to artificially-structured materials such as metamaterials, which function as artificial electromagnetic materials. Some approaches provide surface structures and/or waveguide structures responsive to electromagnetic waves at radio-frequencies (RF) microwave frequencies, and/or higher frequencies such as infrared or visible frequencies. In some approaches the electromagnetic responses include negative refraction. Some approaches provide surface structures that include patterned metamaterial elements in a conducting surface. Some approaches provide waveguide structures that include patterned metamaterial elements in one or more bounding conducting surfaces of the waveguiding structures (e.g. the bounding conducting strips, patches, or planes of planar waveguides, transmission line structures or single plane guided mode structures).

### BRIEF DESCRIPTION OF THE FIGURES

FIG. 1(a) depicts an exemplary untransformed Rotman lens outline.

FIG. 1(b) depicts an exemplary transformed Rotman lens outline corresponding to a coordinate transformation of the untransformed Rotman lens outline of FIG. 1(a). The transformed region is indicated by the shaded rectangle.

FIG. 1(c) depicts a density plot of permeability in the y-direction (μ_{y}) for the exemplary transformed Rotman lens outline of FIG. 1(b).

FIG. 1(d) depicts a outline of a fabricated lens corresponding to the exemplary transformed Rotman lens outline of FIG. 1(b), with output transmission lines 1-10 and an exemplary arrangement of C-dipole elements corresponding to the permeability distribution of FIG. 1(c).

FIG. 2(a) depicts an exemplary unit cell (inset) for a complementary dipole (“C-dipole”) patterned on a parallel plate transmission line, along with a plot of the real and imaginary retrieved permeability corresponding for this exemplary unit cell as a function of the C-dipole length.

FIG. 2(b) depicts the real and imaginary retrieved permeability corresponding to the exemplary unit cell of FIG. 2(a) as a function of frequency for a C-dipole length of 3 mm, for a TE wave traveling perpendicular to the long dimension of the C-dipole.

FIG. 2(c) depicts the real and imaginary retrieved permeability corresponding to the exemplary unit cell of FIG. 2(a) as a function of frequency for a C-dipole length of 3 mm, for a TE wave traveling parallel to the long dimension of the C-dipole.

FIG. 3(a) depicts phase distributions across the output antennas for three nominal focusing directions, for uncompressed, compressed, and control lenses. The uncompressed lens corresponds to the untransformed Rotman lens outline of FIG. 1(a); the compressed lens corresponds to the transformed Rotman lens outline of FIG. 1(b); the control lens corresponds to the transformed Rotman lens outline of FIG. 1(b) but omits the transformed region.

FIG. 3(b) depicts a fabricated lens corresponding to the exemplary transformed Rotman lens outline of FIGS. 1(b) and 1(d).

FIG. 4(a) depicts the far-field radiation pattern for the exemplary uncompressed, compressed, and control lenses (as in FIG. 3(a)), for a nominal focusing direction of 0°.

FIG. 4(b) depicts the far-field radiation pattern for the exemplary uncompressed, compressed, and control lenses (as in FIG. 3(a)), for a nominal focusing direction of 15°.

FIG. 4(c) depicts the far-field radiation pattern for the exemplary uncompressed, compressed, and control lenses (as in FIG. 3(a)), for a nominal focusing direction of 30°.

FIGS. 5-5D depict a wave-guided complementary ELC (magnetic response) structure (FIG. 5) and associated plots of effective permittivity, permeability, wave impedance, and refractive index (FIGS. 1A-1D).

FIGS. 6-6D depict a wave-guided complementary SRR (electric response) structure (FIG. 6) and associated plots of effective permittivity, permeability, wave impedance, and refractive index (FIGS. 6A-6D).

FIGS. 7-7D depict a wave-guided structure with both CSRR and CELC elements (e.g. to provide an effective negative index) (FIG. 7) and associated plots of effective permittivity, permeability, wave impedance, and refractive index (FIGS. 3A-3D).

FIGS. 8-8D depict a wave-guided structure with both CSRR and CELC elements (e.g. to provide an effective negative index) (FIG. 8) and associated plots of effective permittivity, permeability, wave impedance, and refractive index (FIGS. 8A-8D).

FIGS. 9-9D depict a microstrip complementary ELC structure (FIG. 9) and associated plots of effective permittivity, permeability, wave impedance, and refractive index (FIGS. 9A-9D).

FIGS. 10-10D are depict a microstrip structure with both CSRR and CELC elements (e.g. to provide an effective negative index) (FIG. 10) and associated plots of effective permittivity, permeability, wave impedance, and refractive index (FIGS. 10A-10D).

FIG. 11 depicts an exemplary CSRR array as a 2D planar waveguide structure.

FIG. 12-1 depicts retrieved permittivity and permeability of a CSRR element, and

FIG. 12-2 depicts the dependence of the retrieved permittivity and permeability on a geometrical parameter of the CSRR element.

FIGS. 13-1, 13-2 depict field data for 2D implementations of the planar waveguide structure for beam-steering and beam-focusing applications, respectively.

FIGS. 14-1, 14-2 depict an exemplary CELC array as a 2D planar waveguide structure providing an indefinite medium.

FIGS. 15-1, 15-2 depict a waveguide based gradient index lens deployed as a feed structure for an array of patch antennas.

### REFERENCES

[1] S. Weiss A. Zaghloul, O. Kilic and E. D. Adler. Realization of Rotman's concepts of beamformer lenses and artificial dielectric materials. IEEE International Conference on Microwaves, Communications, Antennas and Electronics Systems, page 1, 2009.
[2] N. Kundtz D. Roberts and D. R. Smith. Optical lens compression via transformation optics. Optics Express, 17:16535, 2009.
[3] B. Justice S. Cummer J. Pendry A. Starr D. Schurig, J. Mock and D. Smith. Metamaterial electromagnetic cloak at microwave frequencies. Physical Review Letters, 314:977, 2006.
[4] J. B. Pendry D. Schurig and D. R. Smith. Transformation-designed optical elements. Optics Express, 15:14772, 2007.
[5] 5. R. Gatti R. Sorrentino E. Sbarra, L. Marcaccioli. A novel rotman lens in siw technology. European Microwave Conference, page 1515, 2007.
[6] M. Laso J. Baena J. Bonache M. Beruete R. Marques F. Martyn F. Falcone, T. Lopetegi and M. Sorolla. Babinet principle applied to the design of metasurfaces and metamaterials. Physical Review Letters, 93:1, 2004.
[7] D. Schurig J. B. Pendry and D. R. Smith. Controlling electromagnetic fields. Science, 312:1780, 2006.
[8] T. Zentgraf G. Bartal J. Valentine, J. Li and X. Zhang. Nature Materials, 8:568, 2009.
[9] N. Kundtz and D. R. Smith. Nature Materials, 92:129, 2009.
[10] C. Poitras L. Gabriell, J. Cardenas and M. Lipson. Nature Photonics, 117:461, 2009.
[11] H. Hansenb L. Halla and D. Abbotta. Rotman lens for mm-wavelengths. Proc. of SPIE, 4935:215, 2002.
[12] J. Li and J. B. Pendry. Physical Review Letters, 101:203901, 2008.
[13] L. Musa and M. S. Smith. Microstrip port design and sidewall absorption for printed rotman lenses. IEEE Proceedings, 136:53, 1989.
[14] P. Sharma P. Singhal and R. Gupta. Rotman lens with equal height of array and feed contours. Proc. Of SPIE, 51:2048, 2003.
[15] H. Feng Q. Cheng and T. J. Cui. Broadband planar luneburg lens based on complementary metamaterials. Physical Review Letters, 95:1, 2009.
[16] W. Rotman and R. F. Turner. Wide-angle microwave lens for line source applications. IEEE Transactions on Antennas and Propagation, page 623, 1963.
[17] L. Schulwitz and A. Mortazawi. A new low loss rotman lens design using a graded dielectric substrate. IEEE Transactions on Microwave Theory and Techniques, 56:2734, 2008.
[18] J. B. Pendry, D. Schurig, D. R. Smith Science 312, 1780 (2006). [0089] [2] D. Schurig, J. J. Mock, B. J. Justice, S. A. Cumlller, J. B. Pendry, A. F. Starr and D. R. Smith, Science 314, 977-980 (2006).
[19] R. Liu, T. J. Cui, D. Huang, B. Zhao, D. R. Smith, Physical Review E 76, 026606 (2007).
[20] C. Kinel, Solid State Physics (John Wiley & Sons, New York, 1986), 6.sup.th ed., p. 275.
[21] D. R. Smith, P. M. Rye, J. J. Mock, D. C. Vier, A. F. Starr Physical Review Letters, 93, 137405 (2004).
[22] T. Driscoll, et. al. Applied Physics Letters 88, 081101 (2006).
[23] B. J. Justice, J. J. Mock, L. Guo, A. Degiron, D. Schurig, D. R. Smith, Optics Express 14, 8694 (2006).

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Microwave lenses are of continuing interest as beam-forming and other quasi-optical elements for imaging and communication applications. The Rotman lens is commonly used in wide-angle, beam-forming applications since its inherent two-dimensional geometry makes it low profile and amenable to printed circuit board fabrication [1, 11, 14, 16]. The Rotman lens generally consists of a parallel plate transmission line with a set of input ports and a set of output ports. Each of the output ports feeds a transmission line (e.g. a microstrip or coaxial waveguide) with a prescribed electrical length that, in turn, feeds an antenna. The relative positions of the input and output ports and the electrical lengths of each output feed are determined by the Rotman lens equations. The solution of these equations is such that when a single input feed is excited, the phase distribution across the antennas produces a collimated beam traveling in the direction determined by the position of the excited port [16]. In order to emulate a substantially reflectionless open boundary around the periphery of the planar lens, the parallel plate region between the input and output ports may be terminated with impedance matched dummy ports. The positions of the dummy ports are not prescribed by the Rotman lens equations and in some approaches these dummy ports are configured in a manner that reduces reflections back into the lens [11, 13].

Implemented using transmission line techniques, the Rotman lens can be extremely thin—e.g., for a circuit board implementation, roughly the thickness of the circuit board substrate. For many applications, however, it may be desirable to further reduce the size of the lens by compressing the structure along the in-plane directions. Such a compression can be achieved by applying the techniques associated with Transformation Optics (TO) [7, 9, 12]. TO provides a means to alter the geometry of an optical or quasi-optical device while, in principle, maintaining substantially the performance and wave properties of the original geometry. Coordinate transformations that achieve the desired design are applied to arrive at a set of spatially varying constitutive parameters; the resulting specified medium then is used to implement the transformation [2]. The permittivity and permeability tensors for a transformed device typically vary spatially and are anisotropic. Though TO designs may be difficult to achieve in general with conventional materials, metamaterials provide the means to implement complex TO media. Some exemplary transformation optical approaches have been described in Pendry et al, “Electromagnetic cloaking method,” U.S. Patent Application Publication No. 2008/0024792; Pendry et al, “Electromagnetic compression apparatus, methods, and systems,” U.S. Pat. No. 7,733,289; and Bowers et al, “Focusing and sensing apparatus, methods, and systems,” U.S. Patent Application Publication No. 2009/0296237; each of which is herein incorporated by reference.

In previous work, the patterning of substrates to form an effective gradient index region within a Rotman lens has been applied as a means of improving overall performance [5, 17]. The introduction of a lattice of air holes in the circuit board material with varying density, for example, results in an isotropic, graded index that can be used to improve the focusing properties of the lens. Such modifications were shown to reduce the power entering the dummy ports, lowering the overall insertion loss of the device and improving the gain at more extreme scan angles [17]. The modified Rotman designs that employ graded index materials make use of multiple fabrication steps to create the necessary material distributions in the substrate material of the transmission line structures The exemplary TO design considered here, like these prior examples, makes use of a graded medium to enable the size reduction of the lens; however, the effective medium has an anisotropic, magnetic response, which does not require a patterned dielectric substrate and is achievable even in approaches where there is no substrate (e.g. in non-PCB implementations wherein the parallel plate transmission line has two conducting surfaces separated by vacuum or air). In the exemplary TO design, properties of the original Rotman lens are carried over to the size-reduced version, so that no additional lens equations or optimization is needed to achieve the compressed design. An optimized design can be transformed to reduce its size while maintaining its performance. The complementary electric dipole metamaterials used to achieve the effective magnetic response in the exemplary TO design are voids patterned into one of the metal layers of a transmission line structure, and these void patterns may be fabricated (for example) in the same step as the Rotman transmission line structure itself, e.g. using only a single layer circuit board.

In the exemplary approach presented here, a compressed Rotman lens is designed using Transformation Optics (TO). While TO has been used to create exotic electromagnetic media such as “invisibility” cloaks, it has also been applied to modify or improve the operation of more conventional optical devices, such as lenses [3, 4, 8-10, 12]. TO can also be used to decrease the profile of an optical device by applying a coordinate transformation that compresses the space in which the optical device is embedded [2]. For example, a transformation can be chosen that distorts virtual space, described by unprimed coordinates (x, y, z)=(x₁, x₂, x₃), into a desired physical space, described by primed coordinates (x′, y′, z′)=(x₁′, x₂′, x₃′). Physical space represents the actual location and geometry of the device when implemented, through which waves will behave as though propagating in the virtual space. A transformation can be implemented by varying the permittivity ∈′ and permeability μ′ tensors throughout the physical space in a manner determined by

$${ɛ}_{{i}^{′} {j}^{′}} = {μ}_{{i}^{′} {j}^{′}} \frac{{A}_{i}^{{i}^{′}} {A}_{j}^{{j}^{′}}}{det ( A )} \qquad ( 1 )$$

where A is the Jacobian of the transformation and where Aᵢ^{i′}=dxᵢ′/dxⱼ.

Arbitrary transformations result in spatial variations in both the permeability and permittivity tensors of a device, usually with independent spatial variations in each of the elements. Since an infinite number of possible transformations over some region will lead to identical input and output fields, there is a great amount of freedom in selecting transformations that produce more readily realized constitutive parameters. In addition, in the short wavelength limit where the spatial variations in the material parameters are small over the length scale of a wavelength, the ray optics approximation becomes valid and only the index of refraction is important in describing wave propagation. Thus an eikonal approximation can be made in which only the index of refraction prescribed by the transformation is maintained and the impedance is ignored. 2 For example, for transverse electric (TE) polarization and propagation in the plane perpendicular to the z-axis, the relevant indices are

nₓ=\sqrt{μ_{y}∈_{z}}

n_{y}=\sqrt{μₓ∈_{z}.} (2)

We can then define:

∈_{z}′=1

μ_{y}′=μ_{y}∈_{z}

μ_{z}′=μₓ∈_{z} (3)

such that the indices are maintained but only the permeability in the plane of propagation need be controlled. This is the case relevant to a Rotman lens because propagation in the parallel plate region of the lens is TE and in-plane. It is important to note that when the eikonal approximation for a transformation is employed, the structure may not be inherently impedance matched. Thus, even though the transformation is valid in the ray optics regime, scattering may occur at the boundaries of the transformed region. In some approaches this scattering can be alleviated by choice of transformation; certain transformations will more gradually transition from the input and output ports, producing less overall scattering.

To reduce the overall size of the exemplary compressed Rotman lens, we transform the space within the parallel plate region of the Rotman lens. The exemplary transformation is contained entirely within the boundaries of the lens so that the input and output contours are the same as obtained from the Rotman lens equations but shifted towards one another by an amount determined by the transformation.

The exemplary transformation implemented here is parabolic in the coordinate along the optical axis of the lens and compresses space along the optical axis (x-axis) of the Rotman lens. The transformation is achieved in such a manner that the constitutive parameters approach their free space values at the boundaries of the transformed region. The exemplary transformation is given by

$$\frac{d {x}^{′}}{d x} ( x ) = \{ \begin{matrix}( 1 - c ) {( \frac{2 x - {l}_{1} - {l}_{2}}{{l}_{1} - {l}_{2}} )}^{2} + c , & {l}_{1} < x < {l}_{2} \\ 1 , & x \leq {l}_{1} or x \geq {l}_{2}\end{matrix} \qquad ( 4 )$$

where c∈[0,1] is a free parameter that controls the degree of compression. l₁ and l₂ are the boundaries of the transformation in virtual, untransformed, space. The degree of compression is constrained by the realizable material parameters, with larger compressions requiring larger material parameters.

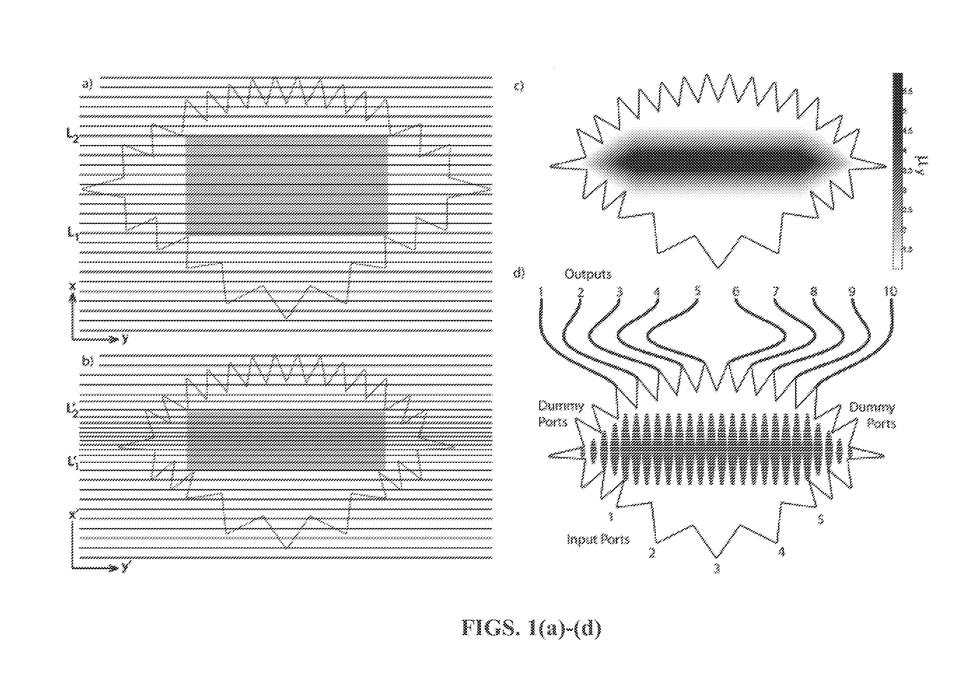

This expression can be integrated to determine the coordinate map,

$${x}^{′} ( x ) = \{ \begin{matrix}\frac{( 1 - c )}{6 {( {l}_{1} - {l}_{2} )}^{2}} {( 2 x - {l}_{1} - {l}_{2} )}^{3} + cx + {x}_{0} , & {l}_{1} < x < {l}_{2} \\ {l}_{1}^{′} ( x - {l}_{1} ) , & x \leq {l}_{1} \\ {l}_{2}^{′} + ( x - {l}_{2} ) , & x \geq {l}_{2}\end{matrix} \qquad ( 5 )$$

where x₀ is a constant that determines the translation of the transformed region. This transformation and the transformed Rotman lens outline are shown in FIGS. 1(a)-(b).

The transformation of Eqn. (5) implies a set of constitutive tensor elements that satisfy ∈_{z} (x)=μ_{y}(x) 1/μₓ [symbol] x). In order to simplify the fabrication of the lens, an eikonal approximation of the form given in Eqn. (3) may be used. The approximated material parameters are then, ∈_{z}′=μₓ′ 1, [symbol] _{y}′ μ_{y}². In this approach, only the permeability in the y-direction, perpendicular to the optical axis and in the plane of the parallel plates, needs to be controlled. In many material systems, controlling the permeability can be difficult, especially if broad-band and low-loss behavior is desired. In the exemplary design presented here, we resolve this difficulty by taking advantage of the transmission line geometry of the Rotman lens and use complementary metamaterials to achieve the desired permeability.

Complementary metamaterials are planar metamaterials or metasurfaces, where the metal and dielectric comprising the material unit cell have been exchanged as compared with bulk metamaterials. Various complementary metamaterials are described in Smith et al, “Metamaterials for surfaces and waveguides,” U.S. Patent Application Publication No. 2010/0156573, which is herein incorporated by reference.

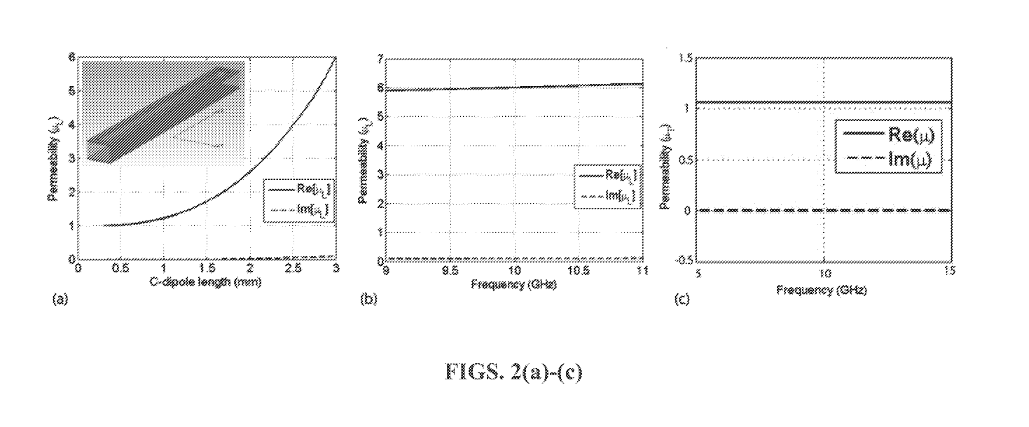

An example of a complementary metamaterial unit cell is depicted in FIG. 2, which shows (as inset of FIG. 2(a)) the unit cell for a complementary electric dipole (C-Dipole) as a slot cut into a metal sheet. By the Babinet principle, these structures exhibit the dual material response to their bulk counterparts; so, the C-dipole gives rise to an effective magnetic response, allowing for the control of permeability. Furthermore, since the C-Dipoles are non-resonant, their magnetic response can have a broad frequency bandwidth, be anisotropic, and exhibit low-loss. FIG. 2 shows the effective permeability, retrieved from simulations, of the C-dipole structure used in the exemplary fabricated lens (the unit cell used in the fabricated lens was 300 μm wide patterned in 17 μm thick copper on a 200 μm FR4 substrate). The permittivity for all frequencies and propagation directions is equal to the substrate permittivity. The maximum achievable permeability is limited by the maximum length of the of the C-dipole, which is in turn constrained by the operating wavelength such that an effective medium approximation is valid, and by the minimum feature size that is consistent with the fabrication technique. Increasing the C-dipole area density (e.g. by using a lithographic technique that supports smaller features) can increase the range of attainable permeabilities. In some approaches the range of attainable permeabilities may be increased by disposing a magnetic material (such as a ferrite) adjacent to the complementary metamaterial elements (e.g. within apertures defining the complementary metamaterial elements).

The eikonal approximation is useful in some approaches because it simplifies the material parameters and the device fabrication. It may however introduce reflections that would be not exist were the full material parameters corresponding to the exact transformation implemented. By choosing a transformation for which the gradient smoothly goes to one at the boundaries of the transformed region, in this case a parabolic transformation, these reflections are substantially diminished. Furthermore, in the example presented here, the transformation is truncated in the y-direction (see the shaded rectangle in FIG. 1(a)). To reduce reflections from a truncation boundary, the permeability is linearly graded in the y-direction from the value at the boundary of the transformation to unity. This does not correspond to a true transformation of the field in these regions, and the phase entering the dummy ports is modified as compared to the untransformed lens.

The exemplary uncompressed lens was designed for 10 GHz operation using the Rotman lens equations with angular range a of ±30° and focal length, F, of 0.1 meter. Five input ports and ten output ports were used. The nominal focusing directions for the input ports were −30°, −15°, 0°, +15°, and +30°. The free parameter g in the Rotman design equations was set to value of 1+α²/2, where α=30°, as recommended by Rotman and Turner. 16 The dummy port positions were determined by placing them along the lines tangent to the extremes of the input and output contours. The exemplary compressed lens was then obtained from this design by shifting the input and output boundaries toward each other according to Eqn. (5), where c=0.41 was chosen such that our maximum permeability was equal to our maximum achievable (the degree of compression could be increased by using a lithographic technique that supports smaller features). This shift of the boundaries corresponded to a 27% decrease in the length of the Rotman lens along the optical axis. The dummy port positions for the transformed lens were determined in the same manner as for the untransformed lens. The region between l₁ and l₂ was then patterned with C-dipoles to achieve the anisotropic index corresponding to Eqn. (4) and Eqn. (3) by interpolating FIG. 2 for the appropriate length of the C-dipole. A control lens was also designed such that the boundaries of the lens were identical to the compressed lens but the material parameters required to implement the transformation were omitted.

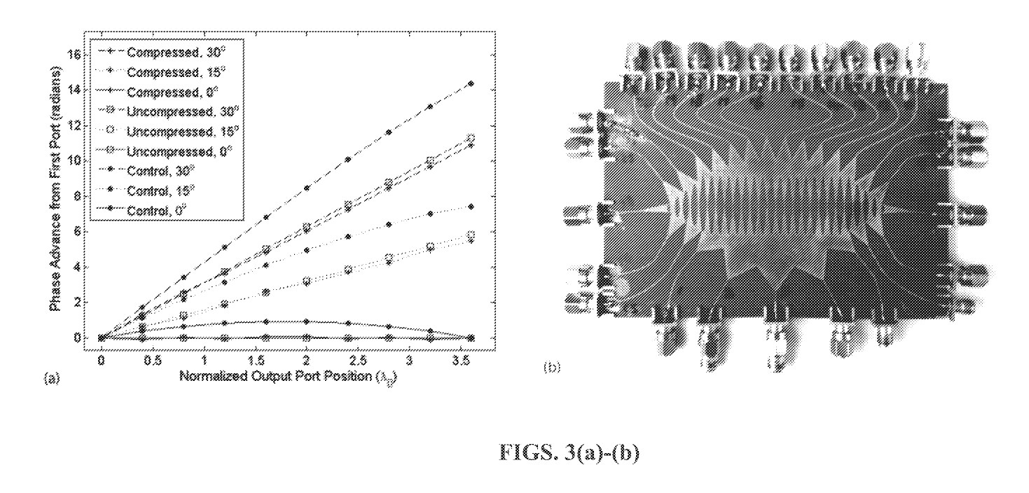

FIG. 3 shows the analytical phase distribution across the output ports for the exemplary uncompressed, compressed and control lens. While the ideal phase distribution is not exactly preserved through the transformation, it is much closer to the ideal phase distribution than the control phase distribution. The control lens shows a shift in the phase slope, which corresponds to a shift in the propagation direction, as well as a deviation from linearity, which corresponds to defocusing of the beam.

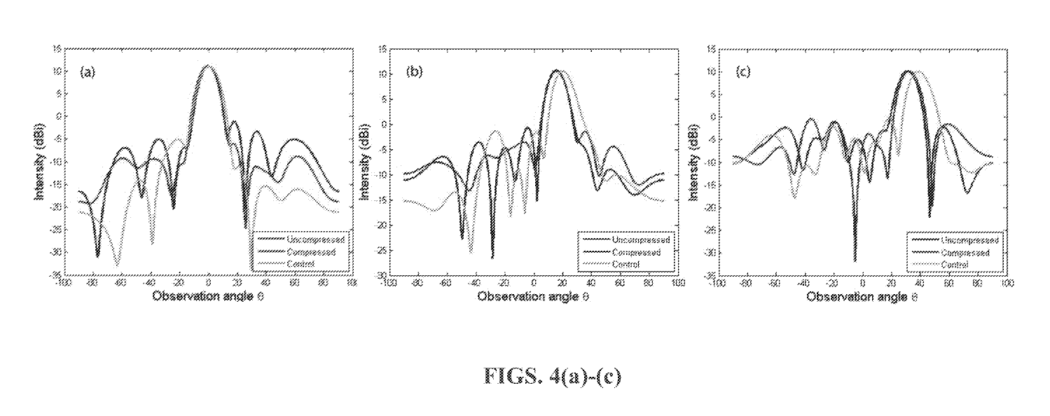

The uncompressed, compressed, and control lenses were fabricated on 0.2 mm FR4 using standard circuit board fabrication techniques. An Agilent E8364B PNA Series network analyzer was used to measure the multi-port scattering matrix from which the output phase distribution, far-field pattern, and loss characteristics were calculated. The far-field radiation pattern, as depicted in FIG. 4, was calculated by assuming the output ports of the lenses feeds an array of matched perfect line sources.

As expected from the analytic phase distributions, the control lens shows both a wider beam and a divergence from the nominal focusing direction. The transformed lens, on the other hand, substantially preserves the width and direction of the uncompressed beam, though some mismatch in the side lobes is seen. The beam full-width-at-half-max (FWHM) for the uncompressed and compressed lenses is 17°_{FBHM} for all nominal focusing directions while the control lens FWHM is 19°_{FBHM} for the 0° nominal focusing direction and 20°_{FBHM} for the 15° and 30° nominal focusing directions. While the true focusing directions for the uncompressed and compressed lenses are exactly equal to the nominal directions, the control lens shows deviation with increasing nominal direction. The deviation from the nominal focusing direction for the control lens is 0°, 5°, and 10° for the 0°, 15°, and 30° nominal directions, respectively. This is summarized in the following table:

TABLE 1
FWHM/(θ_{actual}-θₙₒₘᵢₙₐₗ) for each lens and for each nominal
focusing direction.

| Focusing direction | 0° ₙₒₘᵢₙₐₗ | 15° ₙₒₘᵢₙₐₗ | 30° ₙₒₘᵢₙₐₗ |
|---|---|---|---|
| Uncompressed | 17°/0° | 17°/0° | 17°/0° |
| Compressed | 17°/0° | 17°/0° | 17°/0° |
| Control | 19°/0° | 20°/5° | 20°/10° |

The variation in the side lobes is caused by reflections at the boundaries of the transformation region due to the eikonal approximation and truncation of the transformation in the y-direction. The transformed lens shows a larger average return loss (P_{incldent}P_{reflected}) of 5.674 dB compared to 6.484 dB for the untransformed lens, and a radiative loss (P_{incident}/P_{radiated}) due to the C-dipoles of 9.01 dB. The increased return loss is due to reflections introduced by the eikonal approximation. These losses both contribute to an average insertion loss of 1.448 dB.

While the preceding example has presented a compressed version of a Rotman lens, the approaches described herein may be used to axially compress other structures, such as non-Rotman bootlace-type lenses, planar Luneberg lenses, or other waveguide lenses.

While the preceding example has presented a particular coordinate transformation (i.e. a parabolic compression along the optical axis), the choice of coordinate transformation is not unique and other embodiments may employ other coordinate transformations. For example, other embodiments may provide a coordinate transformation that extends into the ports regions of the parallel plate waveguide, or that flattens the curvature of the input port region and/or the output port region (e.g. to allow a further diminishing of the spatial extent of the parallel plate waveguide along the optical axis), or that provides a further compression along a direction perpendicular to the optical axis, or any combination thereof. Other embodiments may provide an adjustable coordinate transformation (this may be implemented, for example, using metamaterial elements that are adjustable to provide correspondingly adjustable effective medium parameters, e.g. as described in Smith et al, “Metamaterials for surfaces and waveguides,” previously cited). An adjustable coordinate transformation could be used, for example, to provide fine steering of the output beam, by providing an apparent location of an input port intermediate two actual input port locations.

Moreover, in some approaches, the effective medium provided in the parallel plate waveguide need not correspond to a pure coordinate transformation. For example, the effective medium may provide a coordinate transformation region that is truncated to some extent (e.g. at the left and right edges of the shaded rectangle in FIG. 1(b)), preceded and/or succeed by an impedance matching layer (IML) (e.g. as described in Smith et al, “Metamaterials for surfaces and waveguides,” previously cited), etc. As another example, the effective medium could provide additional index gradients to steer power away from dummy ports to reduce the insertion loss and to correct the aberrations seen at the off-focus ports.

While the preceding example has used an eikonal approach to reduce the number of effective constitutive parameters to one (the permeability in the y-direction, μ_{y}), other embodiments need not rely on this eikonal approach. As shown in Smith et al, “Metamaterials for surfaces and waveguides,” previously cited, an arrangement of complementary M-type elements (such as “CSRR” elements) can provide an effective permittivity ∈_{z}, and an arrangement of complementary E-type elements (such as “CELC” elements) can provide effective permeabilities μₓ and μ_{y} (or along any two directions parallel to the parallel plate waveguide). Alternatively or additionally, gradients of the permittivity ∈_{z} can be achieved by patterning a substrate dielectric within the parallel plate waveguide (e.g. with a varying density of air holes).

Artificially structured materials such as metamaterials can extend the electromagnetic properties of conventional materials and can provide novel electromagnetic responses that may be difficult to achieve in conventional materials. Metamaterials can realize complex anisotropies and/or gradients of electromagnetic parameters (such as permittivity, permeability, refractive index, and wave impedance), whereby to implement electromagnetic devices such as invisibility cloaks (see, for example, J. Pendry et al, “Electromagnetic cloaking method,” U.S. patent application Ser. No. 11/459,728, herein incorporated by reference) and GRIN lenses (see, for example, D. R Smith et al, “Metamaterials,” U.S. patent application Ser. No. 11/658,358, herein incorporated by reference). Further, it is possible to engineer metamaterials to have negative permittivity and/or negative permeability, e.g. to provide a negatively refractive medium or an indefinite medium (i.e. having tensor-indefinite permittivity and/or permeability; see, for example, D. R. Smith et al, “Indefinite materials,” U.S. patent application Ser. No. 10/525,191, herein incorporated by reference).

The basic concept of a “negative index” transmission line, formed by exchanging the shunt capacitance for inductance and the series inductance for capacitance, is shown, for example, in Pozar, Microwave Engineering (Wiley 3d Ed.). The transmission line approach to metamaterials has been explored by Itoh and Caloz (UCLA) and Eleftheriades and Balmain (Toronto). See for example Elek et al, “A two-dimensional uniplanar transmission-line metamaterial with a negative index of refraction”, New Journal of Physics (Vol. 7, Issue 1 pp. 163 (2005); and U.S. Pat. No. 6,859,114.

The transmission lines (TLs) disclosed by Caloz and Itoh are based on swapping the series inductance and shunt capacitance of a conventional TL to obtain the TL equivalent of a negative index medium. Because shunt capacitance and series inductance always exist, there is always a frequency dependent dual behavior of the TLs that gives rise to a “backward wave” at low frequencies and a typical forward wave at higher frequencies. For this reason, Caloz and Itoh have termed their metamaterial TL a “composite right/left handed” TL, or CRLH TL. The CRLH TL is formed by the use of lumped capacitors and inductors, or equivalent circuit elements, to produce a TL that functions in one dimension. The CRLH TL concept has been extended to two dimensional structures by Caloz and Itoh, and by Grbic and Eleftheriades.

Use of a complementary split ring resonator (CSRR) as a microstrip circuit element was proposed in F. Falcone et al., “Babinet principle applied to the design of metasurfaces and metamaterials,” Phys. Rev. Lett. V93, Issue 19, 197401. The CSRR was demonstrated as a filter in the microstrip geometry by the same group. See e.g., Marques et al, “Ab initio analysis of frequency selective surfaces based on conventional and complementary split ring resonators”, Journal of Optics A: Pure and Applied Optics, Volume 7, Issue 2, pp. S38-S43 (2005), and Bonache et al., “Microstrip Bandpass Filters With Wide Bandwidth and Compact Dimensions” (Microwave and Optical Tech. Letters (46:4, p. 343 2005). The use of CSRRs as patterned elements in the ground plane of a microstrip was explored. These groups demonstrated the microstrip equivalent of a negative index medium, formed using CSRRs patterned in the ground plane and capacitive breaks in the upper conductor. This work was extended to coplanar microstrip lines as well.

A split-ring resonator (SRR) substantially responds to an out-of-plane magnetic field (i.e. directed along the axis of the SRR). The complementary SRR (CSRR), on the other hand, substantially responds to an out-of-plane electric field (i.e. directed along the CSRR axis). The CSRR may be regarded as the “Babinet” dual of the SRR and embodiments disclosed herein may include CSRR elements embedded in a conducting surface, e.g. as shaped apertures, etchings, or perforation of a metal sheets. In some applications as disclosed herein, the conducting surface with embedded CSRR elements is a bounding conductor for a waveguide structure such as a planar waveguide, microstrip line, etc.

While split-ring resonators (SRRs) substantially couple to an out-of-plane magnetic field, some metamaterial applications employ elements that substantially couple to an in-plane electric field. These alternative elements may be referred to as electric LC (ELC) resonators, and exemplary configurations are depicted in D. Schurig et al, “Electric-field coupled resonators for negative permittivity metamaterials,” Appl. Phys. Lett 88, 041109 (2006). While the electric LC (ELC) resonator substantially couples to an in-plane electric field, the complementary electric LC (CELC) resonator substantially responds to an in-plane magnetic field. The CELC resonator may be regarded the “Babinet” dual of the ELC resonator, and embodiments disclosed herein may include CELC resonator elements (alternatively or additionally to CSRR elements) embedded in a conducting surface, e.g. as shaped apertures, etchings, or perforations of a metal sheet. In some applications as disclosed herein, a conducting surface with embedded CSRR and/or CELC elements is a bounding conductor for a waveguide structure such as a planar waveguide, microstrip line, etc.

Some embodiments disclosed herein employ complementary electric LC (CELC) metamaterial elements to provide an effective permeability for waveguide structures. In various embodiments the effective (relative) permeability may be greater then one, less than one but greater than zero, or less than zero. Alternatively or additionally, some embodiments disclosed herein employ complementary split-ring-resonator (CSRR) metamaterial elements to provide an effective permittivity for planar waveguide structures. In various embodiments the effective (relative) permittivity may be greater then one, less than one but greater than zero, or less than zero.

Exemplary non-limiting features of various embodiments include:

Structures for which an effective permittivity, permeability, or refractive index is near zero, and for which an effective permittivity, permeability, or refractive index is less than zero.

Structures for which an effective permittivity or permeability is an indefinite tensor (i.e. having both positive and negative eigenvalues).

Gradient structures, e.g. for beam focusing, collimating, or steering, impedance matching structures, e.g. to reduce insertion loss; and feed structures for antenna arrays.

Use of complementary metamaterial elements such as CELCs and CSRRs to substantially independently configure the magnetic and electric responses, respectively, of a surface or waveguide, e.g. for purposes of impedance matching, gradient engineering, or dispersion control.

Use of complementary metamaterial elements having adjustable physical parameters to provide devices having correspondingly adjustable electromagnetic responses (e.g. to adjust a steering angle of a beam steering device or a focal length of a beam focusing device)

Surface structures and waveguide structures that are operable at RF, microwave, or even higher frequencies (e.g. millimeter, infrared, and visible wavelengths)

Various embodiments disclosed herein include “complementary” metamaterial elements, which may be regarded as Babinet complements of original metamaterial elements such as split ring resonators (SRRs) and electric LC resonators (ELCs).

The SRR element functions as an artificial magnetic dipolar “atom,” producing a substantially magnetic response to the magnetic field of an electromagnetic wave. Its Babinet “dual,” the complementary split ring resonator (CSRR), functions as an electric dipolar “atom” embedded in a conducting surface and producing a substantially electric response to the electric field of an electromagnetic wave. While specific examples are described herein that deploy CSRR elements in various structures, other embodiments may substitute alternative elements. For example, any substantially planar conducting structure having a substantially magnetic response to an out-of-plane magnetic field (hereafter referred to as a “M-type element,” the SRR being an example thereof) may define a complement structure (hereafter a “complementary M-type element,” the CSRR being an example thereof), which is a substantially-equivalently-shaped aperture, etching, void, etc. within a conducting surface. The complementary M-type element will have a Babinet-dual response, i.e. a substantially electric response to an out-of-plane electric field. Various M-type elements (each defining a corresponding complementary M-type element) may include: the aforementioned split ring resonators (including single split ring resonators (SSRRs), double split ring resonators (DSRRs), split-ring resonators having multiple gaps, etc.), omega-shaped elements (cf. C. R. Simovski and S. He, arXiv:physics/0210049), cut-wire-pair elements (cf. G. Dolling et al, Opt. Lett. 30, 3198 (2005)), or any other conducting structures that are substantially magnetically polarized (e.g. by Faraday induction) in response to an applied magnetic field.

The ELC element functions as an artificial electric dipolar “atom,” producing a substantially electric response to the electric field of an electromagnetic wave. Its Babinet “dual,” the complementary electric LC (CELC) element, functions as a magnetic dipolar “atom” embedded in a conducting surface and producing a substantially magnetic response to the magnetic field of an electromagnetic wave. While specific examples are described herein that deploy CELC elements in various structures, other embodiments may substitute alternative elements. For example, any substantially planar conducting structure having a substantially electric response to an in-plane electric field (hereafter referred to as a “E-type element,” the ELC element being an example thereof) may define a complement structure (hereafter a “complementary E-type element,” the CELC being an example thereof), which is a substantially-equivalently-shaped aperture, etching, void, etc. within a conducting surface. The complementary E-type element will have a Babinet-dual response, i.e. a substantially magnetic response to an in-plane magnetic field. Various E-type elements (each defining a corresponding complementary E-type element) may include: capacitor-like structures coupled to oppositely-oriented loops (as in FIGS. 1, 3, 4, 5, 6, and 10-1, with other exemplary varieties depicted in D. Schurig et al, “Electric-field-coupled resonators for negative permittivity metamaterials,” Appl. Phys. Lett. 88, 041109 (2006) and in H.-T. Cen et al, “Complementary planar terahertz metamaterials,” Opt. Exp. 15, 1084 (2007)), closed-ring elements (cf. R. Liu et al, “Broadband gradient index optics based on non-resonant metamaterials,” unpublished; see attached Appendix), I-shaped or “dog-bone” structures (cf. R. Liu et al, “Broadband ground-plane cloak,” Science 323, 366 (2009)), cross-shaped structures (cf. H.-T. Cen et al, previously cited), or any other conducting structures that are substantially electrically polarized in response to an applied electric field. In various embodiments, a complementary E-type element may have a substantially isotropic magnetic response to in-plane magnetic fields, or a substantially anisotropic magnetic response to in-plane magnetic fields.

While an M-type element may have a substantial (out-of-plane) magnetic response, in some approaches an M-type element may additionally have an (in-plane) electric response that is also substantial but of lesser magnitude than (e.g. having a smaller susceptibility than) the magnetic response. In these approaches, the corresponding complementary M-type element will have a substantial (out-of-plane) electric response, and additionally an (in-plane) magnetic response that is also substantial but of lesser magnitude than (e.g. having a smaller susceptibility than) the electric response. Similarly, while an E-type element may have a substantial (in-plane) electric response, in some approaches an E-type element may additionally have an (out-of-plane) magnetic response that is also substantial but of lesser magnitude than (e.g. having a smaller susceptibility than) the electric response. In these approaches, the corresponding complementary E-type element will have a substantial (in-plane) magnetic response, and additionally an (out-of-plane) electric response that is also substantial but of lesser magnitude than (e.g. having a smaller susceptibility than) the magnetic response.

Some embodiments provide a waveguide structure having one or more bounding conducting surfaces that embed complementary elements such as those described previously. In a waveguide context, quantitative assignment of quantities typically associated with volumetric materials—such as the electric permittivity, magnetic permeability, refractive index, and wave impedance—may be defined for planar waveguides and microstrip lines patterned with the complementary structures. For example, one or more complementary M-type elements such as CSRRs, patterned in one or more bounding surfaces of a waveguide structure, may be characterized as having an effective electric permittivity. Of note, the effective permittivity can exhibit both large positive and negative values, as well as values between zero and unity, inclusive. Devices can be developed based at least partially on the range of properties exhibited by the M-type elements, as will be described. The numerical and experimental techniques to quantitatively make this assignment are well-characterized.

Alternatively or additionally, in some embodiments complementary E-type elements such as CELCs, patterned into a waveguide structure in the same manner as described above, have a magnetic response that may be characterized as an effective magnetic permeability. The complementary E-type elements thus can exhibit both large positive and negative values of the effective permeability, as well as effective permeabilities that vary between zero and unity, inclusive (throughout this disclosure, real parts are generally referred to in the descriptions of the permittivity and permeability for both the complementary E-type and complementary M-type structures, except where context dictates otherwise as shall be apparent to one of skill in the art) Because both types of resonators can be implemented in the waveguide context, virtually any effective material condition can be achieved, including negative refractive index (both permittivity and permeability less than zero), allowing considerable control over waves propagating through these structures. For example, some embodiments may provide effective constitutive parameters substantially corresponding to a transformation optical medium (as according to the method of transformation optics, e.g. as described in J. Pendry et al, “Electromagnetic cloaking method,” U.S. patent application Ser. No. 11/459,728).

Using a variety of combinations of the complementary E- and/or M-type elements, a wide variety of devices can be formed. For example, virtually all of the devices that have been demonstrated by Caloz and Itoh using CRLH TLs have analogs in the waveguiding metamaterial structures described here. Most recently, Silvereinha and Engheta proposed an interesting coupler based on creating a region in which the effective refractive index (or propagation constant) is nearly zero (CITE). The equivalent of such a medium can be created by the patterning of complementary E- and/or M-type elements into the bounding surfaces of a waveguide structure. The Figures show and describe exemplary illustrative non-limiting realizations of the zero index coupler and other devices with the use of patterned waveguides and several depictions as to how exemplary non-limiting structures may be implemented.

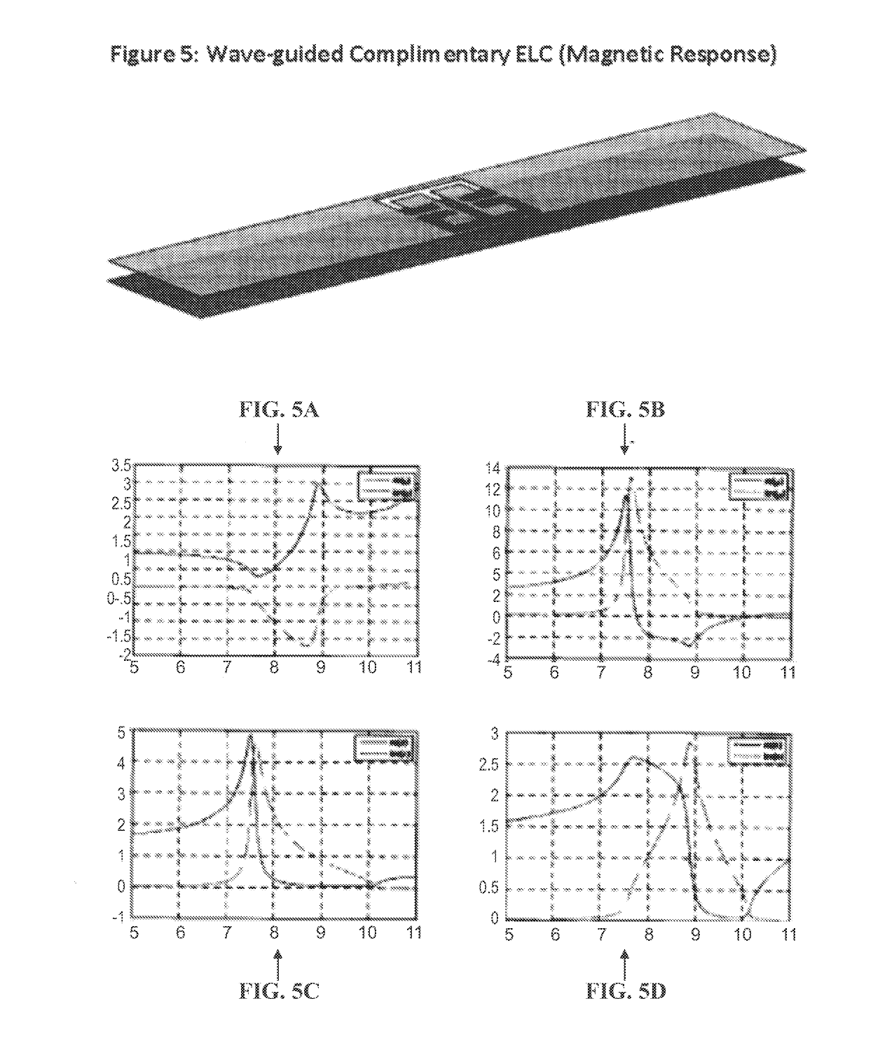

FIG. 5 shows an exemplary illustrative non-limiting wave-guided complementary ELC (magnetic response) structure, and FIGS. 5A-5D show associated exemplary plots of the effective index, wave impedance, permittivity and permeability. While the depicted example shows only a single CELC element, other approaches provide a plurality of CELC (or other complementary E-type) elements disposed on one or more surfaces of a waveguide structure.

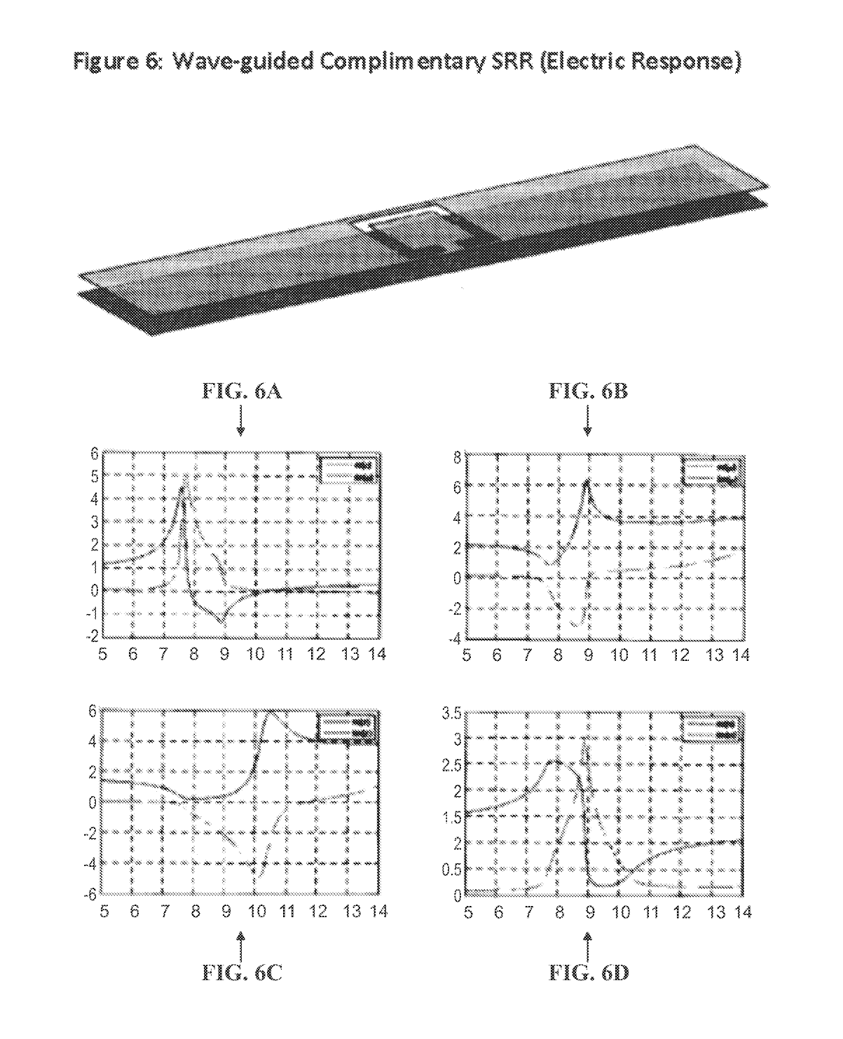

FIG. 6 shows an exemplary illustrative non-limiting wave-guided complementary SRR (electric response) structure, and FIGS. 6A-6D show associated exemplary plots of the effective index, wave impedance, permittivity and permeability. While the depicted example shows only a single CSRR element, other approaches provide a plurality of CSRR elements (or other complementary M-type) elements disposed on one or more surfaces of a waveguide structure.

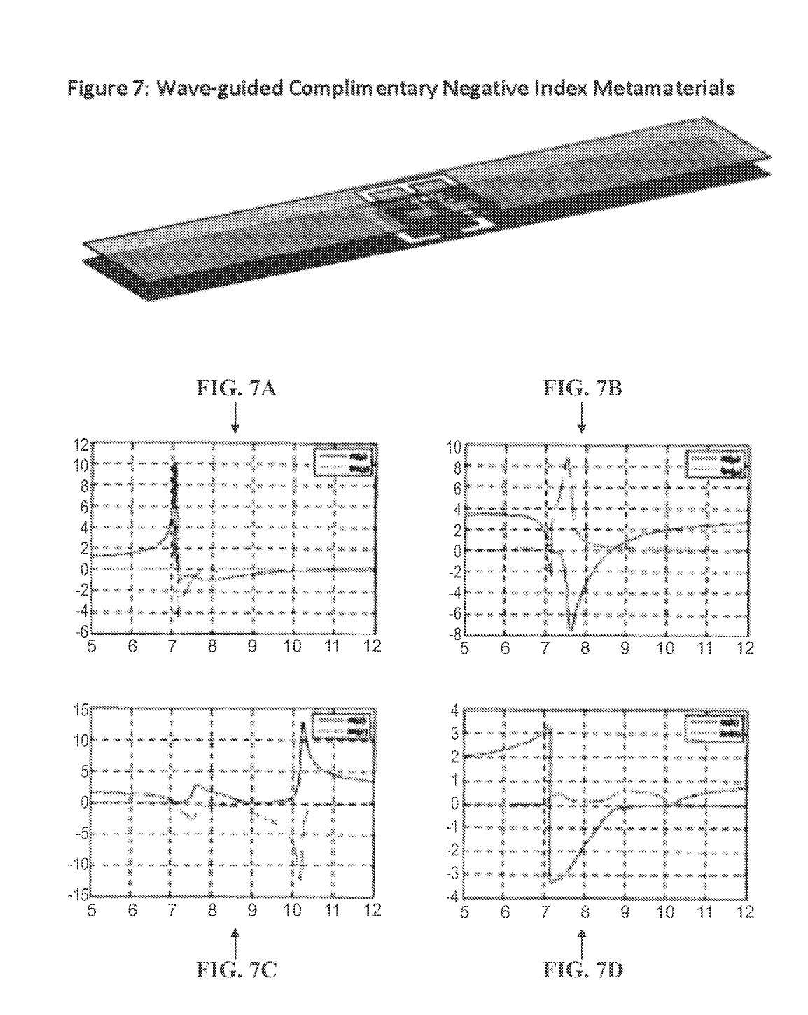

FIG. 7 shows an exemplary illustrative non-limiting wave-guided structure with both CSRR and CELC elements (e.g. to provide an effective negative index) in which the CSRR and CELC are patterned on opposite surfaces of a planar waveguide, and FIGS. 7A-7D show associated exemplary plots of the effective index, wave impedance, permittivity and permeability. While the depicted example shows only a single CELC element on a first bounding surface of a waveguide and a single CSRR element on a second bounding surface of the waveguide, other approaches provide a plurality of complementary E- and/or M-type elements disposed on one or more surfaces of a waveguide structure.

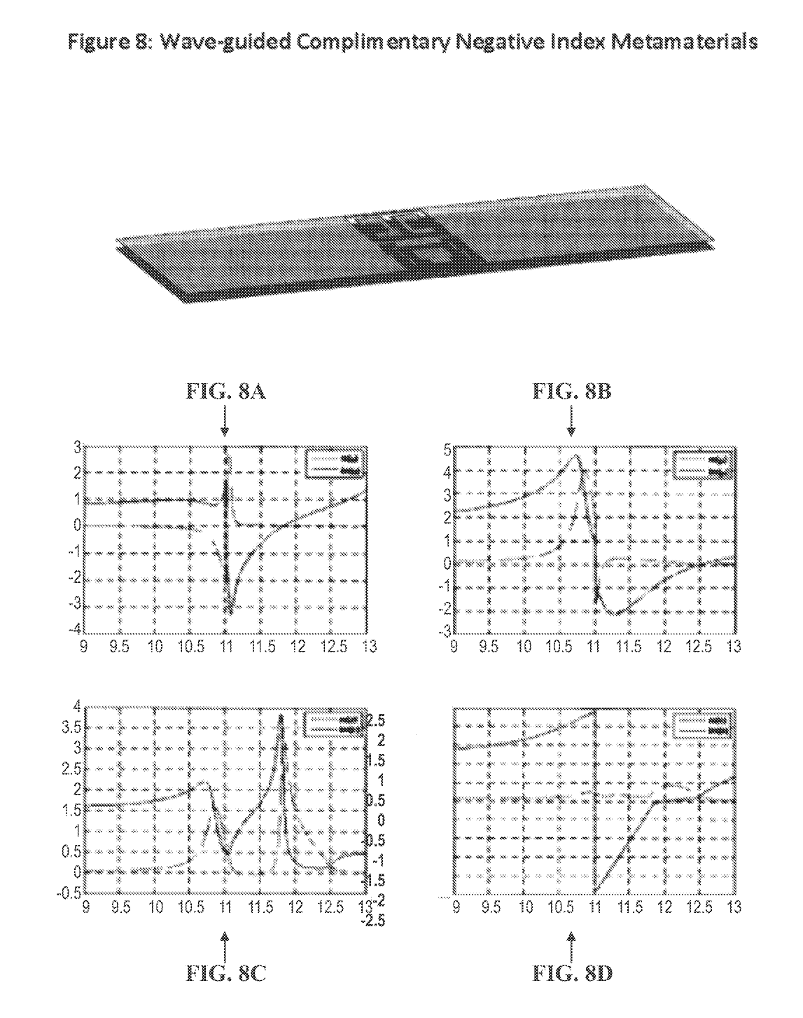

FIG. 8 shows an exemplary illustrative non-limiting wave-guided structure with both CSRR and CELC elements (e.g. to provide an effective negative index) in which the CSRR and CELC are patterned on the same surface of a planar waveguide, and FIGS. 8A-8D show associated exemplary plots of the effective index, wave impedance, permittivity and permeability. While the depicted example shows only a single CELC element and a single CSRR element on a first bounding surface of a waveguide, other approaches provide a plurality of complementary E- and/or M-type elements disposed on one or more surfaces of a waveguide structure.

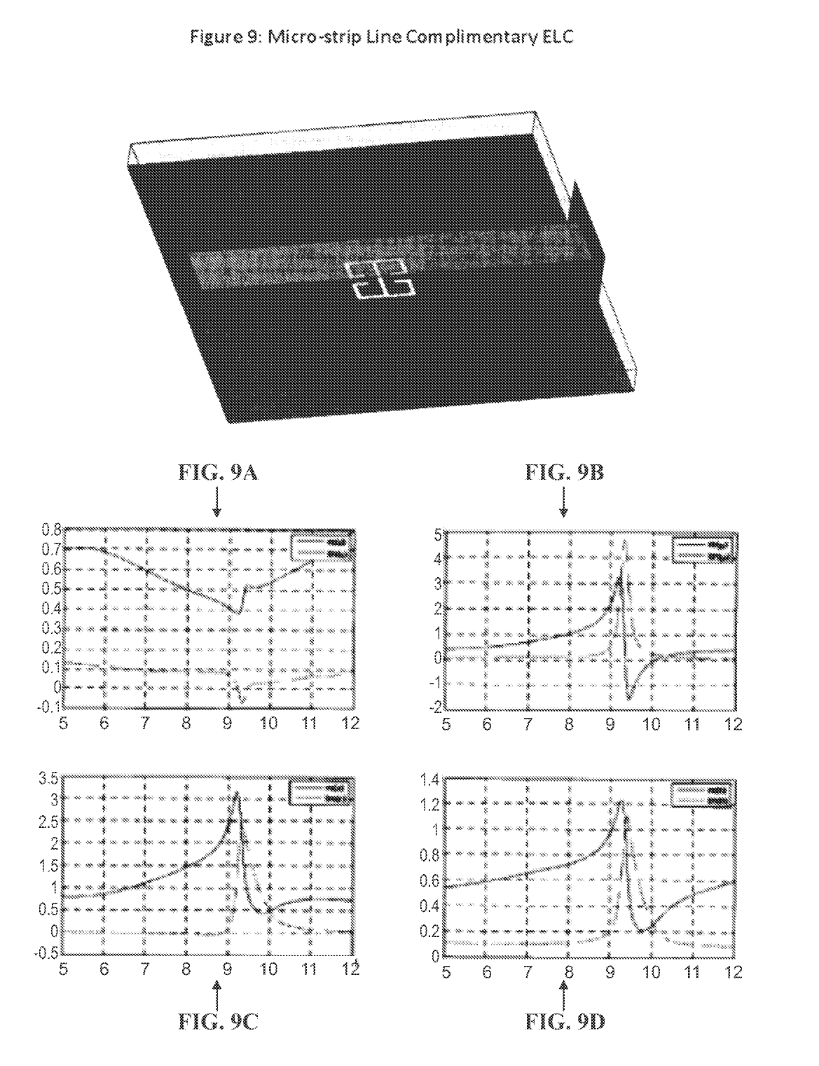

FIG. 9 shows an exemplary illustrative non-limiting microstrip complementary ELC structure, and FIGS. 9A-9D show associated exemplary plots of the effective index, wave impedance, permittivity and permeability. While the depicted example shows only a single CELC element on the ground plane of a microstrip structure, other approaches provide a plurality of CELC (or other complementary E-type) elements disposed on one or both of the strip portion of the microstrip structure or the ground plane portion of the microstrip structure.

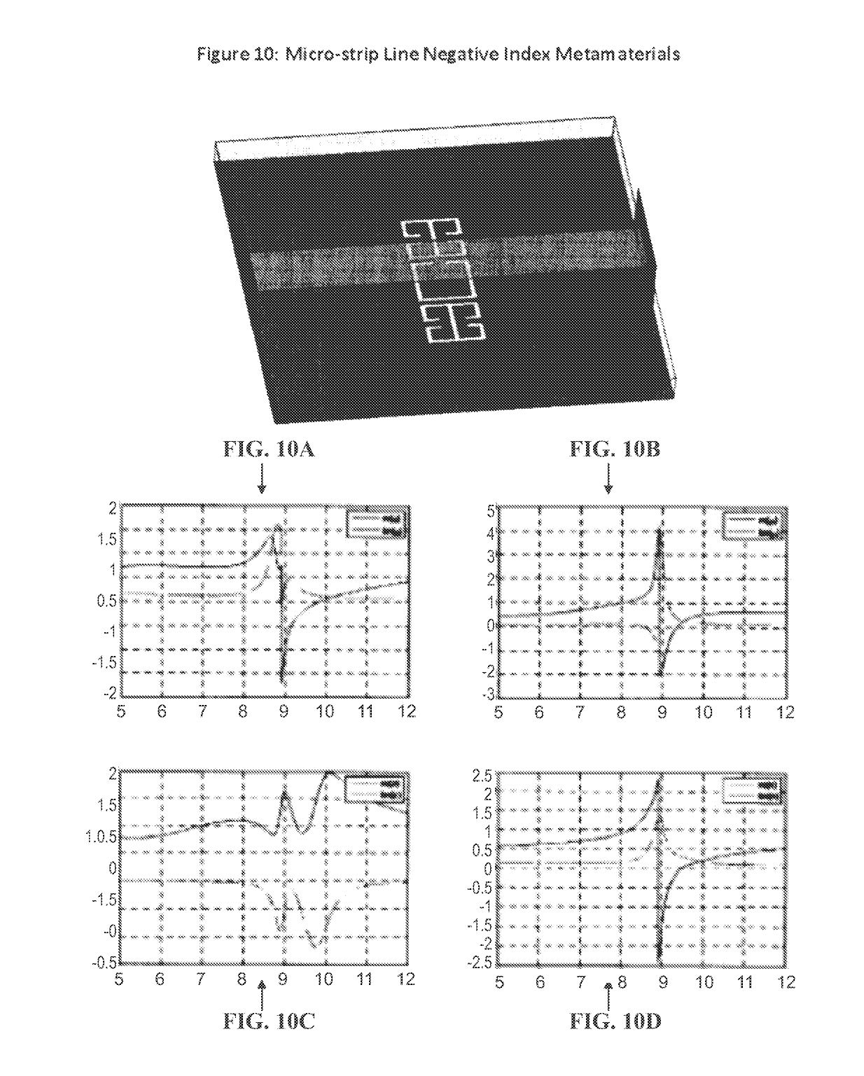

FIG. 10 shows an exemplary illustrative non-limiting micro-strip line structure with both CSRR and CELC elements (e.g. to provide an effective negative index), and FIGS. 10A-10D show associated exemplary plots of the effective index, wave impedance, permittivity and permeability. While the depicted example shows only a single CSRR element and two CELC elements on the ground plane of a microstrip structure, other approaches provide a plurality of complementary E- and/or M-type elements disposed on one or both of the strip portion of the microstrip structure or the ground plane portion of the microstrip structure.

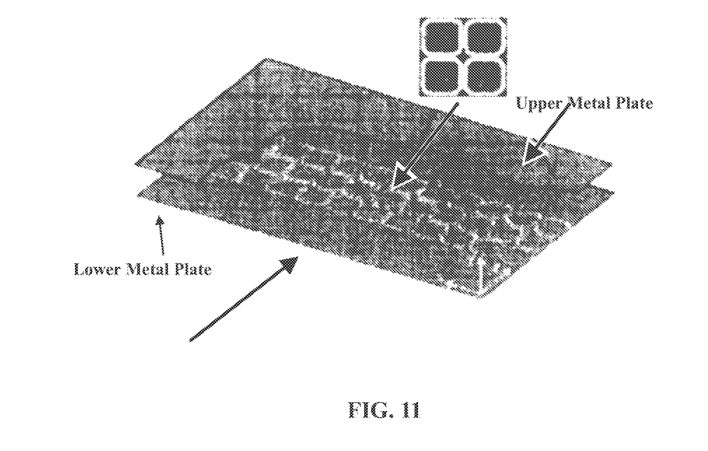

FIG. 11 illustrates the use of a CSRR array as a 2D waveguide structure. In some approaches a 2D waveguide structure may have bounding surfaces (e.g. the upper and lower metal places depicted in FIG. 11) that are patterned with complementary E- and/or M-type elements to implement functionality such as impedance matching, gradient engineering, or dispersion control.

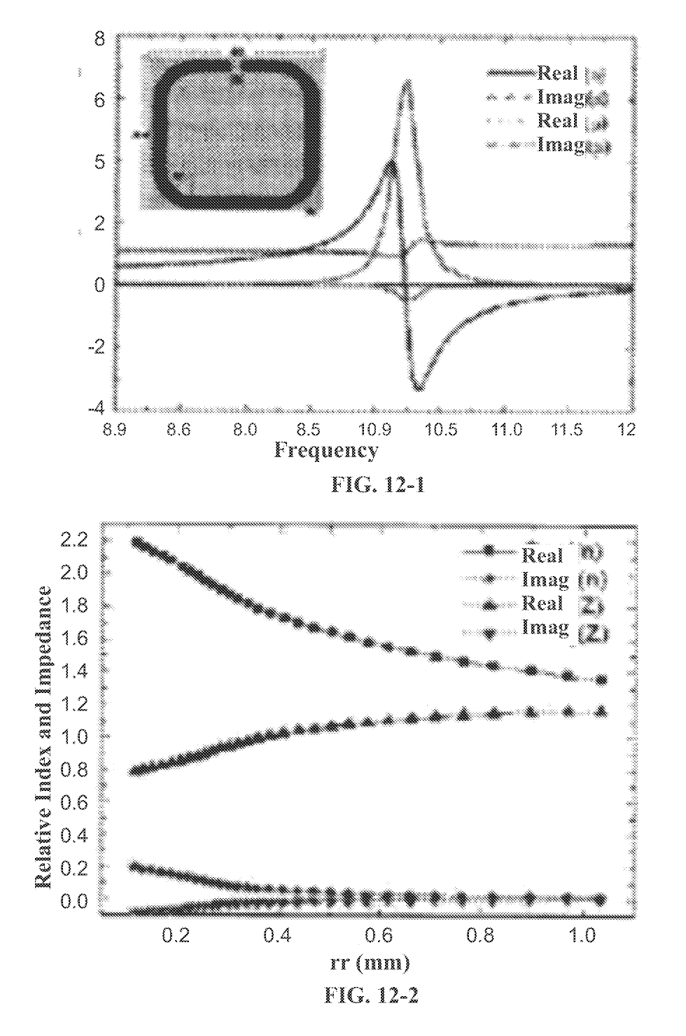

As an example of gradient engineering, the CSRR structure of FIG. 11 has been utilized to form both gradient index beam-steering and beam-focusing structures. FIG. 12-1 illustrates a single exemplary CSRR and the retrieved permittivity and permeability corresponding to the CSRR (in the waveguide geometry). By changing parameters within the CSRR design (in this case a curvature of each bend of the CSRR), the index and/or the impedance can be tuned, as shown in FIG. 12-2.

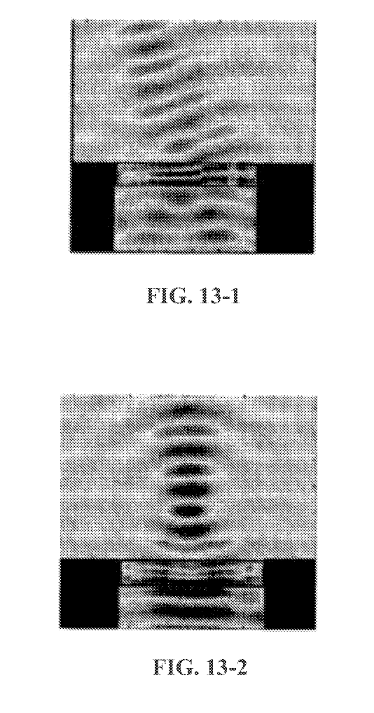

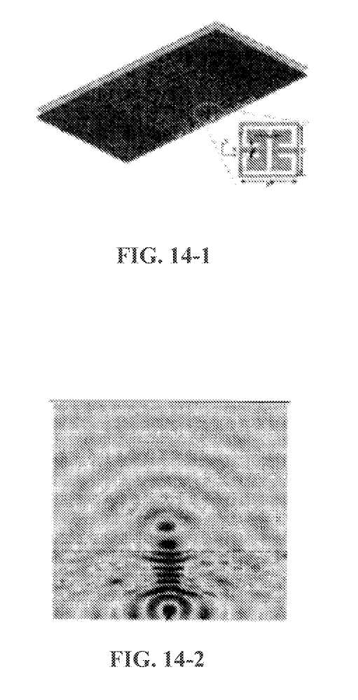

A CSRR structure laid out as shown in FIG. 11, with a substantially linear gradient of refractive index imposed along the direction transverse to the incident guided beam, produces an exit beam that is steered to an angle different from that of the incident beam. FIG. 13-1 shows exemplary field data taken on a 2D implementation of the planar waveguide beam-steering structure. The field mapping apparatus has been described in considerable detail in the literature [B. J. Justice, J. J. Mock, L. Guo, A. Degiron, D. Schurig, D. R. Smith, “Spatial mapping of the internal and external electromagnetic fields of negative index metamaterials,” Optics Express, vol. 14, p. 8694 (2006)]. Likewise, implementing a parabolic refractive index gradient along the direction transverse to the incident beam within the CSRR array produces a focusing lens, e.g. as shown in FIG. 13-2. More generally, a transverse index profile that is a concave function (parabolic or otherwise) will provide a positive focusing effect, such as depicted in FIG. 13-2 (corresponding to a positive focal length); a transverse index profile that is a convex function (parabolic or otherwise) will provide a negative focusing effect (corresponding to a negative focal length, e.g. to receive a collimated beam and transmit a diverging beam). For approaches wherein the metamaterial elements include adjustable metamaterial elements (as discussed below), embodiments may provide an apparatus having an electromagnetic function (e.g. beam steering, beam focusing, etc.) that is correspondingly adjustable. Thus, for example, a beam steering apparatus may be adjusted to provide at least first and second deflection angles; a beam focusing apparatus may be adjusted to provide at least first and second focal lengths, etc. An example of a 2D medium formed with CELCs is shown in FIGS. 14-1, 14-2. Here, an in-plane anisotropy of the CELCs is used to form an ‘indefinite medium,’ in which a first in-plane component of the permeability is negative while another in-plane component is positive. Such a medium produces a partial refocusing of waves from a line source, as shown in the experimentally obtained field map of FIG. 14-2. The focusing properties of a bulk indefinite medium have previously been reported [D. R. Smith, D. Schurig, J. J. Mock, P. Kolinko, P. Rye, “Partial focusing of radiation by a slab of indefinite media,” Applied Physics Letters, vol. 84, p. 2244 (2004)]. The experiments shown in this set of figures validate the design approach, and show that waveguide metamaterial elements can be produced with sophisticated functionality, including anisotropy and gradients.

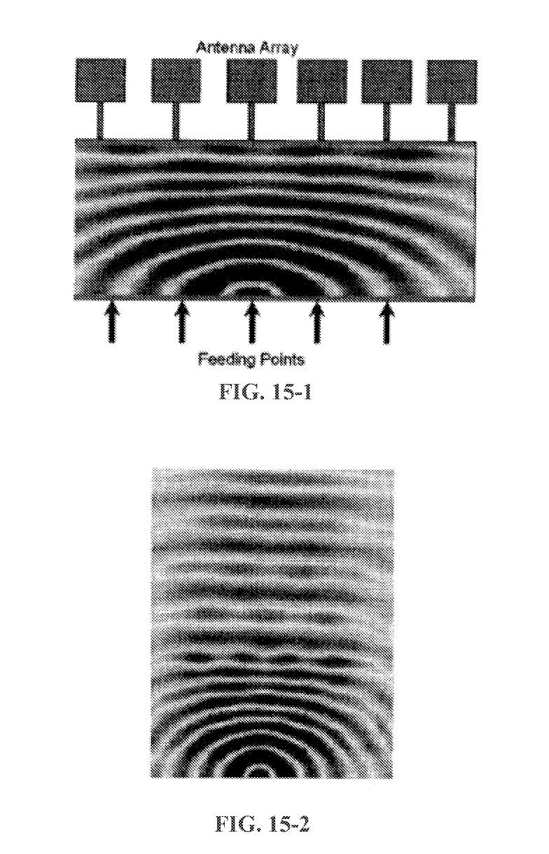

In FIGS. 15-1 and 15-2, a waveguide-based gradient index structure (e.g. having boundary conductors that include complementary E- and/or M-type elements, as in FIGS. 11 and 14-1) is disposed as a feed structure for an array of patch antennas. In the exemplary embodiment of FIGS. 15-1 and 15-2, the feed structure collimates waves from a single source that then drive an array of patch antennas. This type of antenna configuration is well known as the Rotman lens configuration. In this exemplary embodiment, the waveguide metamaterial provides an effective gradient index lens within a planar waveguide, by which a plane wave can be generated by a point source positioned on the focal plane of the gradient index lens, as illustrated by the “feeding points” in FIG. 15-2. For the Rotman Lens antenna, one can place multiple feeding points on the focal plane of the gradient index metamaterial lens and connect antenna elements to the output of the waveguide structure as shown in FIG. 15-1. From well known optics theory, the phase difference between each antenna will depend on the feed position of the source, so that phased-array beam forming can be implemented. FIG. 15-2 is a field map, showing the fields from a line source driving the gradient index planar waveguide metamaterial at the focus, resulting in a collimated beam. While the exemplary feed structure of FIGS. 15-1 and 15-2 depicts a Rotman-lens type configuration for which the antenna phase differences are substantially determined by the location of the feeding point, in other approaches the antenna phase differences are determined by fixing the feeding point and adjusting the electromagnetic properties (and therefore the phase propagation characteristics of) the gradient index fens (e.g. by deploying adjustable metamaterial elements, as discussed below), while other embodiments may combine both approaches (i.e. adjustment of both the feeding point position and the lens parameters to cumulatively achieve the desired antenna phase differences).

In some approaches, a waveguide structure having an input port or input region for receiving electromagnetic energy may include an impedance matching layer (IML) positioned at the input port or input region, e.g. to improve the input insertion loss by reducing or substantially eliminating reflections at the input port or input region. Alternatively or additionally, in some approaches a waveguide structure having an output port or output region for transmitting electromagnetic energy may include an impedance matching layer (IML) positioned at the output port or output region, e.g. to improve the output insertion loss by reducing or substantially eliminating reflections at the output port or output region. An impedance matching layer may have a wave impedance profile that provides a substantially continuous variation of wave impedance, from an initial wave impedance at an external surface of the waveguide structure (e.g. where the waveguide structure abuts an adjacent medium or device) to a final wave impedance at an interface between the IML and a gradient index region (e.g. that provides a device function such as beam steering or beam focusing). In some approaches the substantially continuous variation of wave impedance corresponds to a substantially continuous variation of refractive index (e.g. where turning an arrangement of one species of element adjusts both an effective refractive and an effective wave impedance according to a fixed correspondence, such as depicted in FIG. 12-2), while in other approaches the wave impedance may be varied substantially independently of the refractive index (e.g. by deploying both complementary E- and M-type elements and independently turning the arrangements of the two species of elements to correspondingly independently tune the effective refractive index and the effective wave impedance).

While exemplary embodiments provide spatial arrangements of complementary metamaterial elements having varied geometrical parameters (such as a length, thickness, curvature radius, or unit cell dimension) and correspondingly varied individual electromagnetic responses (e.g. as depicted in FIG. 12-2), in other embodiments other physical parameters of the complementary metamaterial elements are varied (alternatively or additionally to varying the geometrical parameters) to provide the varied individual electromagnetic responses. For example, embodiments may include complementary metamaterial elements (such as CSRRs or CELCs) that are the complements of original metamaterial elements that include capacitive gaps, and the complementary metamaterial elements may be parameterized by varied capacitances of the capacitive gaps of the original metamaterial elements. Equivalently, noting that from Babinet's theorem a capacitance in an element (e.g. in the form of a planar interdigitated capacitor having a varied number of digits and/or varied digit length) becomes an inductance in the complement thereof (e.g. in the form of a meander line inductor having a varied number of turns and/or varied turn length), the complementary elements may be parameterized by varied inductances of the complementary metamaterial elements. Alternatively or additionally, embodiments may include complementary metamaterial elements (such as CSRRs or CELCs) that are the complements of original metamaterial elements that include inductive circuits, and the complementary metamaterial elements may be parameterized by varied inductances of the inductive circuits of the original metamaterial elements. Equivalently, noting that from Babinet's theorem an inductance in an element (e.g. in the form of a meander line inductor having a varied number of turns and/or varied turn length) becomes a capacitance in the complement thereof (e.g. in the form of an planar interdigitated capacitor having a varied number of digits and/or varied digit length), the complementary elements may be parameterized by varied capacitances of the complementary metamaterial elements. Moreover, a substantially planar metamaterial element may have its capacitance and/or inductance augmented by the attachment of a lumped capacitor or inductor. In some approaches, the varied physical parameters (such as geometrical parameters, capacitances, inductances) are determined according to a regression analysis relating electromagnetic responses to the varied physical parameters (c.f. the regression curves in FIG. 12-2).

In some embodiments the complementary metamaterial elements are adjustable elements, having adjustable physical parameters corresponding to adjustable individual electromagnetic responses of the elements. For example, embodiments may include complementary elements (such as CSRRs) having adjustable capacitances (e.g. by adding varactor diodes between the internal and external metallic regions of the CSRRs, as in A. Velez and J. Bonarche, “Varactor-loaded complementary split ring resonators (VLCSRR) and their application to tunable metamaterial transmission lines,” IEEE Microw. Wireless Compon. Lett. 18, 28 (2008)). In another approach, for waveguide embodiments having an upper and a lower conductor (e.g. a strip and a ground plane) with an intervening dielectric substrate, complementary metamaterial elements embedded in the upper and/or lower conductor may be adjustable by providing a dielectric substrate having a nonlinear dielectric response (e.g. a ferroelectric material) and applying a bias voltage between the two conductors. In yet another approach, a photosensitive material (e.g. a semiconductor material such as GaAs or n-type silicon) may be positioned adjacent to a complementary metamaterial element, and the electromagnetic response of the element may be adjustable by selectively applying optical energy to the photosensitive material (e.g. to cause photodoping). In yet another approach, a magnetic layer (e.g. of a ferrimagnetic or ferromagnetic material) may be positioned adjacent to a complementary metamaterial element, and the electromagnetic response of the element may be adjustable by applying a bias magnetic field (e.g. as described in J. Gollub et al, “Hybrid resonant phenomenon in a metamaterial structure with integrated resonant magnetic material,” arXiv:0810.4871 (2008)). While exemplary embodiments herein may employ a regression analysis relating electromagnetic responses to geometrical parameters (cf. the regression curve in FIG. 12-2), embodiments with adjustable elements may employ a regression analysis relating electromagnetic responses to adjustable physical parameters that substantially correlate with the electromagnetic responses.

In some embodiments with adjustable elements having adjustable physical parameters, the adjustable physical parameters may be adjustable in response to one or more external inputs, such as voltage inputs (e.g. bias voltages for active elements), current inputs (e.g. direct injection of charge carriers into active elements), optical inputs (e.g. illumination of a photoactive material), or field inputs (e.g. bias electric/magnetic fields for approaches that include ferroelectrics/ferromagnets). Accordingly, some embodiments provide methods that include determining respective values of adjustable physical parameters (e.g. by a regression analysis), then providing one or more control inputs corresponding to the determined respective values. Other embodiments provide adaptive or adjustable systems that incorporate a control unit having circuitry configured to determine respective values of adjustable physical parameters (e.g. by a regression analysis) and/or provide one or more control inputs corresponding to determined respective values.

While some embodiments employ a regression analysis relating electromagnetic responses to physical parameters (including adjustable physical parameters), for embodiments wherein the respective adjustable physical parameters are determined by one or more control inputs, a regression analysis may directly relate the electromagnetic responses to the control inputs. For example, where the adjustable physical parameter is an adjustable capacitance of a varactor diode as determined from an applied bias voltage, a regression analysis may relate electromagnetic responses to the adjustable capacitance, or a regression analysis may relate electromagnetic responses to the applied bias voltage.

While some embodiments provide substantially narrow-band responses to electromagnetic radiation (e.g. for frequencies in a vicinity of one or more resonance frequencies of the complementary metamaterial elements), other embodiments provide substantially broad-band responses to electromagnetic radiation (e.g. for frequencies substantially less than, substantially greater than, or otherwise substantially different than one or more resonance frequencies of the complementary metamaterial elements). For example, embodiments may deploy the Babinet complements of broadband metamaterial elements such as those described in R. Liu et al, “Broadband gradient index optics based on non-resonant metamaterials,” unpublished; see attached Appendix) and/or in R. Liu et al, “Broadband ground-plane cloak,” Science 323, 366 (2009)).

While the preceding exemplary embodiments are planar embodiments that are substantially two-dimensional, other embodiments may deploy complementary metamaterial elements in substantially non-planar configurations, and/or in substantially three-dimensional configurations. For example, embodiments may provide a substantially three-dimensional stack of layers, each layer having a conducting surface with embedded complementary metamaterial elements. Alternatively or additionally, the complementary metamaterial elements may be embedded in conducting surfaces that are substantially non-planar (e.g. cylinders, spheres, etc.). For example, an apparatus may include a curved conducting surface (or a plurality thereof) that embeds complementary metamaterial elements, and the curved conducting surface may have a radius of curvature that is substantially larger than a typical length scale of the complementary metamaterial elements but comparable to or substantially smaller than a wavelength corresponding to an operating frequency of the apparatus.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An apparatus, comprising:
a parallel plate waveguide having an input port region, an output port region, and a plurality of subwavelength apertures within one or more conducting surfaces of the parallel plate waveguide, the plurality of subwavelength apertures providing a respective plurality of individual electromagnetic responses;
where the plurality of individual electromagnetic responses provides a substantially increased optical distance between the input port region and the output port region.

2. The apparatus of claim 1, wherein the substantially increased optical distance is an optical distance substantially greater than a physical distance between the input port region and the output port region times a refractive index of a substrate of the parallel plate waveguide.

3. The apparatus of claim 1, wherein the substantially increased optical distance corresponds to a substantially decreased physical distance between the input port region and the output port region.

4. The apparatus of claim 1, wherein the input port region and the output port region define an optical axis of the apparatus, and the substantially increased optical distance is an optical distance along the optical axis.

5. The apparatus of claim 4, wherein the plurality of individual electromagnetic responses provides an effective permeability in a direction parallel to the parallel plate waveguide and perpendicular to the optical axis.

6. The apparatus of claim 4, wherein the plurality of individual electromagnetic responses provides an effective permeability in a direction parallel to the parallel plate waveguide and parallel to the optical axis.

7. The apparatus of claim 4, wherein the plurality of individual electromagnetic responses provides an effective permittivity in a direction perpendicular to the parallel plate waveguide.

8. The apparatus of claim 4, wherein the plurality of individual electromagnetic responses provides an effective refractive index for wave propagation parallel to the optical axis substantially greater than an effective refractive index for wave propagation perpendicular to the optical axis.

9. The apparatus of claim 1, wherein the output port region includes a plurality of output ports, and further comprising:
a plurality of transmission lines respectively coupled to the plurality of output ports and configured to feed a respective plurality of antennas.

10. The apparatus of claim 9, wherein the input port region includes a plurality of input ports, and wherein the parallel plate waveguide is configured to produce a substantially collimated output beam from the plurality of antennas responsive to exciting an input port selected from the plurality of input ports, the substantially collimated output beam having a beam direction that is a function of the selected input port.

11. The apparatus of claim 9, wherein the respective plurality of antennas is a respective plurality of patch antennas.

12. The apparatus of claim 9, further comprising:
a plurality of electromagnetic emitters respectively coupled to the plurality of input ports.

13. The apparatus of claim 9, further comprising:
a plurality of electromagnetic receivers respectively coupled to the plurality of input ports.

14. The apparatus of claim 1, wherein the plurality of individual electromagnetic responses includes a plurality of adjustable individual electromagnetic responses.

15. The apparatus of claim 14, wherein the adjustable individual electromagnetic responses are adjustable response to one or more external inputs.

16. The apparatus of claim 15, wherein the one or more external inputs includes one or more voltage inputs.

17. The apparatus of claim 10, wherein the plurality of individual electromagnetic responses includes a plurality of adjustable individual electromagnetic responses that are adjustable responsive to one or more external inputs, and the beam direction is an adjustable beam direction that is a function of the selected input port and the one or more external inputs.

18. The apparatus of claim 17, wherein the adjustable beam direction is adjustable to provide a beam direction in between unadjusted beam directions corresponding to the selected input port and an adjacent input port.

19. A method, comprising:
delivering an electromagnetic wave to a first port region of a parallel plate waveguide; and
compressing the electromagnetic wave as it propagates within the parallel plate waveguide from the first port region to a second port region by a coupling of the electromagnetic wave to a plurality of subwavelength apertures in a conducting surface of the parallel plate waveguide;
where the compressing includes compressing along an axis joining the first port region and the second port region.

20. The method of claim 19, further comprising:
receiving the compressed electromagnetic wave at a plurality of ports within the second port region;
propagating the received electromagnetic wave along a plurality of transmission lines respectively coupled to the plurality of ports to feed a respectively plurality of antennas; and
radiating a substantially collimated beam from the plurality of antennas responsive to the feeding;
where the substantially collimated output beam has a beam direction that is a function of a location of the delivering.

21. The method of claim 20, wherein:
the first port region includes a discrete plurality of input ports;
the delivering includes delivering the electromagnetic wave to an input port selected from the discrete plurality of input ports; and
the substantially collimated output beam has a beam direction that is a function of the selected input port.

22. The method of claim 21, further comprising:
adjusting the beam direction by adjusting the coupling to provide an apparent location of the delivering different than an actual location of the delivering, where the apparent location is in between the selected input port and an adjacent input port.

23. The method of claim 19, further comprising:
receiving electromagnetic energy at a plurality of antennas that feed a respective plurality of transmission lines; and
propagating the received electromagnetic energy along the plurality of transmission lines to provide the delivered electromagnetic wave to the first port region;
where a map of intensity of the compressed electromagnetic wave within the second port region as a function of location within the second port region corresponds to an angular radiation pattern of the received electromagnetic energy.

24. The method of claim 23, wherein the second port region includes a discrete plurality of output ports, and the method further comprises:
adjusting the coupling to provide an apparent location of an output port in between actual locations of adjacent output ports in the discrete plurality of output ports.

25. A method, comprising:
identifying a coordinate transformation that reduces the axial spatial extent of a waveguide lens;
determining electromagnetic medium parameters that correspond to the identified coordinate transformation; and
determining respective physical parameters for a plurality of apertures positionable in one or more conducting surfaces of the waveguide lens to provide effective electromagnetic medium parameters that substantially correspond to the determined electromagnetic medium parameters.

26. The method of claim 25, further comprising:
fabricating the waveguide lens with the plurality of apertures in the one or more conducting surfaces.

27. The method of claim 26, where the fabricating is fabricating by a printed circuit board process.

28. The method of claim 25, wherein the determining respective physical parameters includes determining according to one of a regression analysis and a lookup table.

29. The method of claim 25, wherein the determining of respective physical parameters includes determining geometrical parameters for the plurality of apertures.

30. The method of claim 25, wherein the determining of respective physical parameters includes determining resonant frequencies for the plurality of apertures.

31. The method of claim 25, wherein the waveguide lens is a Rotman lens.
